(19) United States
(12) Patent Application Publication
(10) Pub. No.: US 2012/0291648 A1
(43) Pub. Date: Nov. 22, 2012

(54) METHOD FOR PRODUCING FABRIC MEMORY KEEPSAKE

(76) Inventor: Jane F. Sheinfeld, Chappaqua, NY (US)

(21) Appl. No.: 13/474,424

(22) Filed: May 17, 2012

Related U.S. Application Data
(60) Provisional application No. 61/487,138, filed on May 17, 2011.

(51) Int. Cl. B41F 33/00

(52) U.S. Cl. 101/483

(57) ABSTRACT

A method for producing a fabric keepsake comprises placing a fabric removeably on a poster board so as to form a sign-in board to be used at an event, and so that a surface of the fabric is exposed for marking by guests at the event; removing the fabric from the poster board after the sign-in board has been marked by at least one person, at the event; and forming a keepsake using the fabric. An image can be placed on the fabric, as by printing, prior to the fabric being fastened to the poster board. The keepsake can be a pillow, a wall hanging, a quilt, a blanket, or a table covering such as a tablecloth. The method may comprise producing an image of the fabric after it has been marked at the event; and storing the image for later use in producing a keepsake.

This application claims priority under 35. U.S.C.§119(e) from provisional patent application Ser. No. 61/487,138, filed on May 17, 2011, which is incorporated herein by reference in its entirety.

### BACKGROUND OF THE INVENTION

1. Field of the Invention

The present invention relates to keepsakes used to commemorate an event. More particularly, it relates to a method for making such keepsakes.

2. Background Art

It is a tradition at many events (including but not limited to weddings, sweet sixteens, retirement parties, anniversary parties, bar/bat mitzvahs, etc.) to have an item available for guests to sign and write their well-wishes to the guest(s) of honor. Oftentimes this is a guestbook or a decorated sign-in board. These sign-in boards are generally made of a paper or poster board, or a polymer or other smooth hard surface upon which the marking of a pen or magic marker can be retained. The guest books usually wind up on someone's bookshelf and the sign-in boards, if not framed, often end up in the garage, where they are subject to being damaged, accidentally disposed of, or even being prematurely thrown away.

### SUMMARY OF THE DISCLOSURE

It is an object of the invention to provide a fabric keepsake having thereon markings placed on an event sign-in board.

It is a further object of the invention to provide a method for economically providing such a keepsake.

In accordance with one embodiment of the present invention, a sign-in board is provided with a fabric surface upon which well-wishes or other messages may be written, or upon which other marking or drawings may be made. When the event is over, the fabric is converted from being mounted in sign form to being incorporated into a home decorative item, such as, by way of examples, but not by way of limitation, a pillow, a wall hanging, a quilt a table covering or a blanket.

In accordance with a second embodiment of the invention, the content that has been placed on an existing paper/poster board sign-in board may be placed on a soft fabric item, such as, by way of examples, but not by way of limitation, a pillow, a wall hanging, a quilt, a table covering or a blanket.

Disclosed is a method for producing a fabric keepsake, comprising placing a fabric removeably on a poster board so as to form a sign-in board to be used at an event, so that a surface of the fabric is exposed for marking by guests at the event; removing the fabric from the poster board after the sign-in board has been marked by at least one person, at the event; and forming a keepsake using the fabric.

An image can be placed on the fabric prior to the fabric being fastened to the poster board, by for example, printing. The image can be processed to improve at least one of color and clarity prior to being placed on the fabric. The image can be processed using a software program on a computer. The image can be acquired from a customer of the keepsake, a library of images, or can be designed by the fabricator of the keepsake. The image can be acquired as a digital image file.

A test image can be printed on the fabric to review quality of the image, prior to the fabric being placed on the poster board. Additional processing of the image may be performed if quality of the image is not as is desired.

The poster board is of smaller dimensions than the fabric so as to provide a border of fabric that is not marked at the event. Further, the poster board can be temporarily framed for use at the event.

The fabric can be placed on the poster board by folding a periphery of the fabric so as to contact a side of the poster board that is not to be exposed for marking during the event; and fastening the periphery of the fabric to that side. Fastening can be done by using tape to fasten the periphery of the fabric to the side of the poster board that is not to be exposed for marking. Optionally, a spray glue can be used to assist in the mounting process.

The poster board can have a foam core. The fabric can then be secured to the poster board by using pins extending into the foam core, to secure the fabric peripherally about the poster board.

The fabric can be ironed before it is placed on the poster board to remove wrinkles in the fabric.

The method can comprise producing an image of the fabric after it has been marked at the event; and storing the image for later use in producing a keepsake.

The fabric can used to form a keepsake selected from the group consisting of a pillow, a wall hanging, a quilt, a blanket and a table covering such as, for example, a tablecloth. When the fabric is used to form a keepsake, the method can further comprise specifying whether the keepsake is to have embellishments; specifying, in appropriate cases, a filling material, or specifying one of a color or a design for fabric used to form a back for the keepsake.

Also disclosed is a method for producing a fabric keepsake, comprising printing an image of a poster board that has been marked up at an event, on a fabric; and forming a keepsake using the fabric. Again, the fabric can be used to form a keepsake selected from the group consisting of a pillow, a wall hanging, a quilt, a table covering and a blanket. An image capture device, such as a digital camera, can be used to capture the image of the sign-in board, and to provide a digital file representative of the image. The digital file can be used to print the image.

### BRIEF DESCRIPTION OF THE DRAWINGS

The foregoing aspects and other features of the present invention are explained in the following description, taken in connection with the accompanying drawings, wherein:

FIG. 1 is flow chart of the manner in which a customer image is placed on a fabric that is mounted on a board.

FIG. 2A to FIG. 2K are mostly planar views, and with some side views (FIGS. 2G and 2J), that illustrate the steps in utilizing the fabric produced by the steps of FIG. 1.

### DETAILED DESCRIPTION OF THE PREFERRED EMBODIMENTS

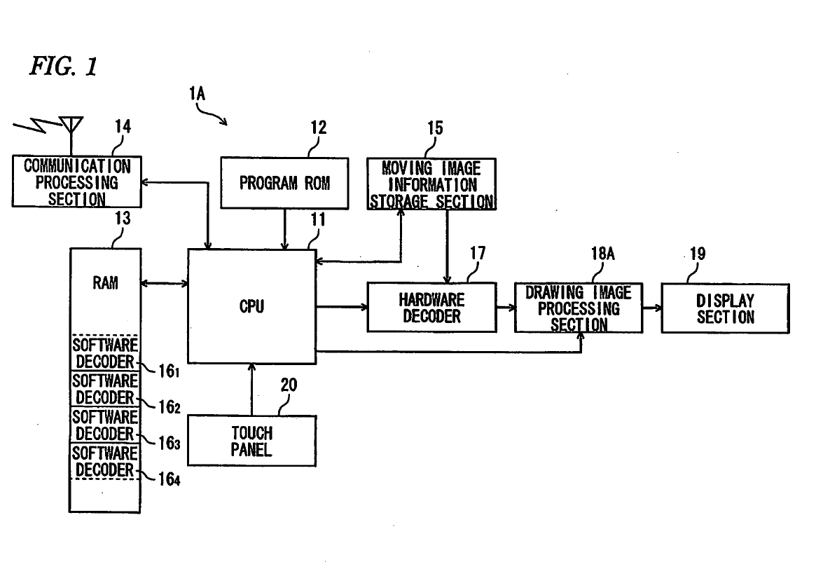

Referring to FIG. 1, in consultation with the customer or client, a determination is made as to the image that should be printed on the fabric sign-in board (as provided by the client, from a library of images, or as created by, for example, the fabricator) and the type of fabric to be used. The image is received at 10. Theoretically, the client supplies a clean digital image for use, but this is checked at 12. This is rarely the case, and more often than not, it is necessary to perform a variety of operations at 14, such as matching typefaces and re-typesetting (English and foreign languages like Hebrew), because a hardcopy scan is often not crisp enough for enlarged printing.

It will be understood that these operations may be performed using software programs of various kinds that are well known in the art, running on a well known, programmed digital computer (not shown).

It is often also necessary to do custom color matching, to be sure the fabric prints in the color the client expects. Color varies based upon the surface it is printed on and the printer that is utilized. Color on paper and color on a monitor are not necessarily the same as the color on fabric, or that printed by various printers. Various checks are performed at 16 to be sure that the image is correct, including conversations with the customer or client, which may provide assurances that the content is correct and acceptable. If the image is not correct, additional corrections are made. When the image appears to be correct at 16, a proof is printed on the appropriate fabric at 18 (the same fabric, or a fabric closely approximating the fabric to be used). When the proof is received an adjustment to color and legibility are made to obtain a final, full-size fabric print. Thus, the image is finalized via proof with the client, and if it is acceptable at 20, a final print is made on the fabric at 22. If it is not, then further processing is conducted at 14. A final check is made at 24, and if the final print is not acceptable, then additional adjustments are made at 14, and the process continues as described above.

If at 12, the client supplied image is acceptable, then processing continues to 20, and as described above. In either case, if the final print is correct at 24, the fabric with the print thereon, is mounted on a board at 26, as described below. Smaller boards can be printed with smaller scale equipment, which a fabricator may have in-house. Otherwise the facilities of a vendor having larger equipment can be utilized for the proof and the final printing.

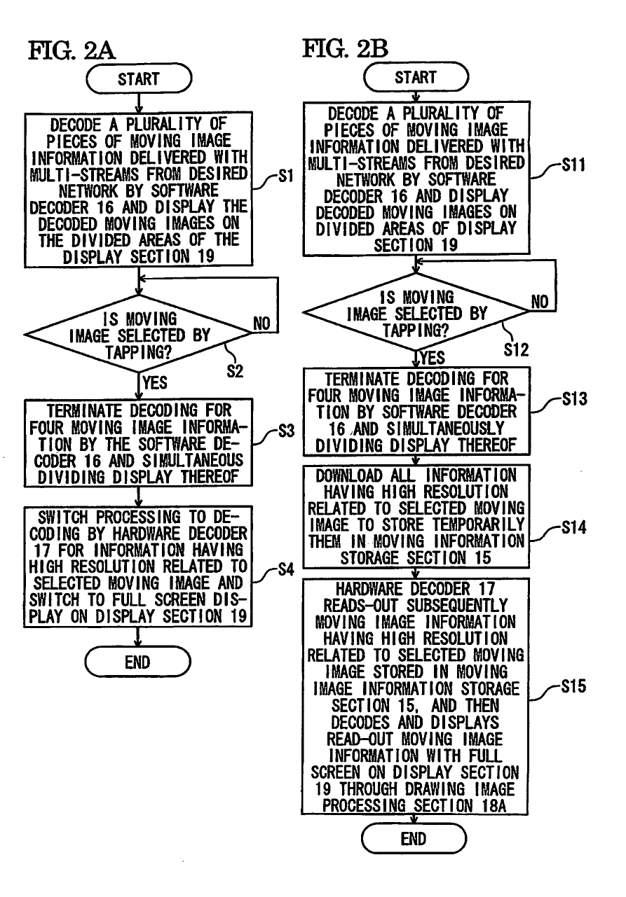

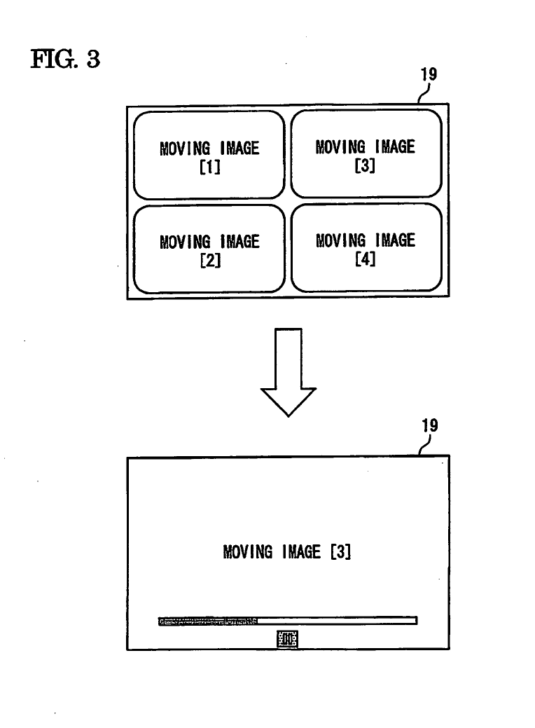

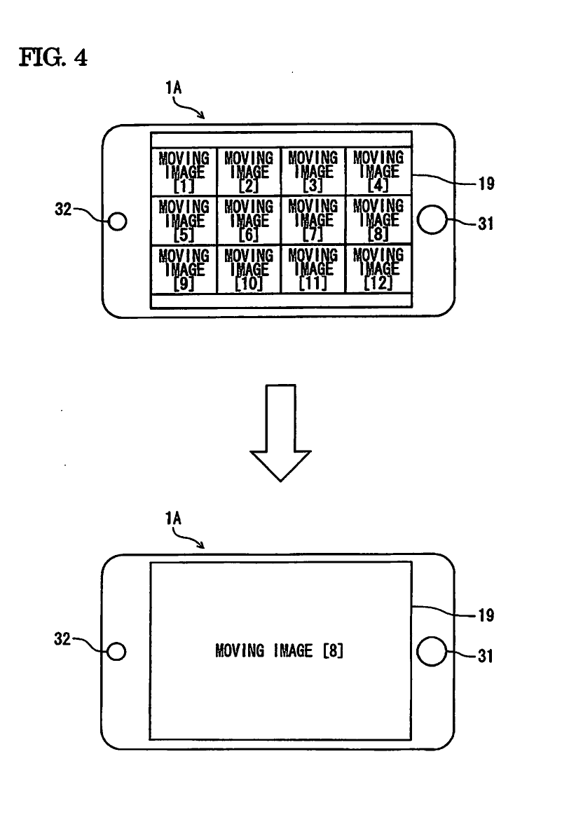

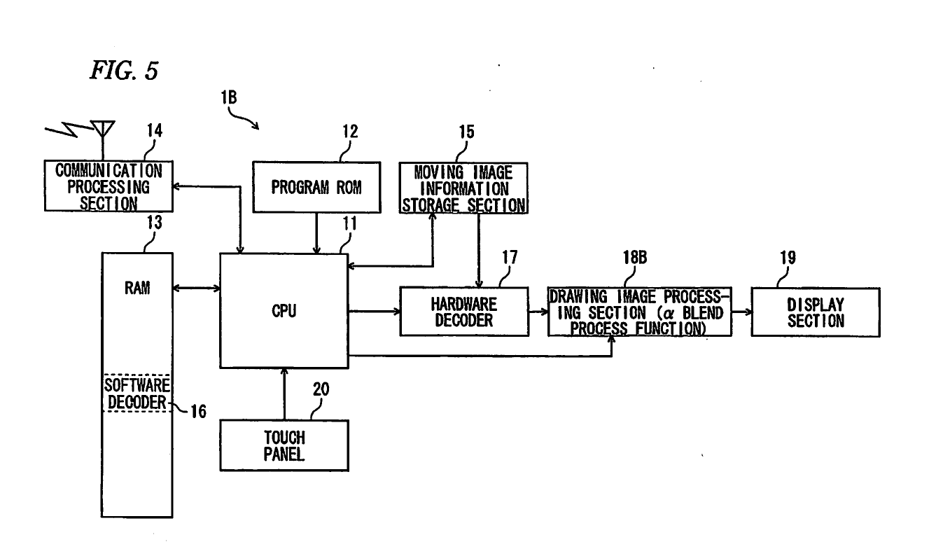

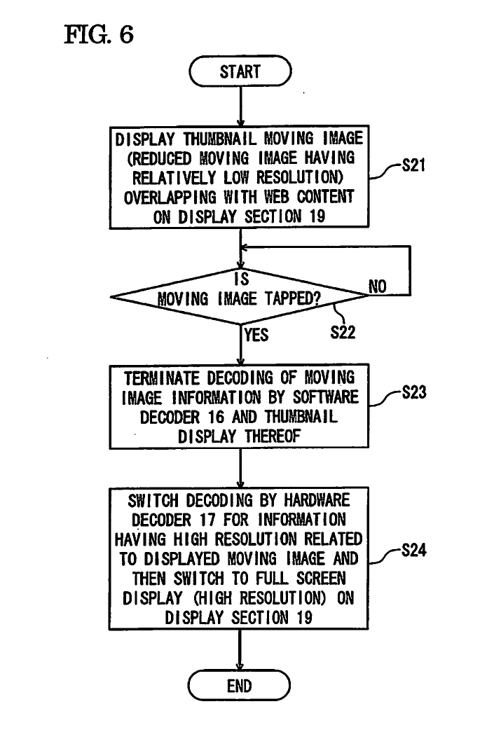

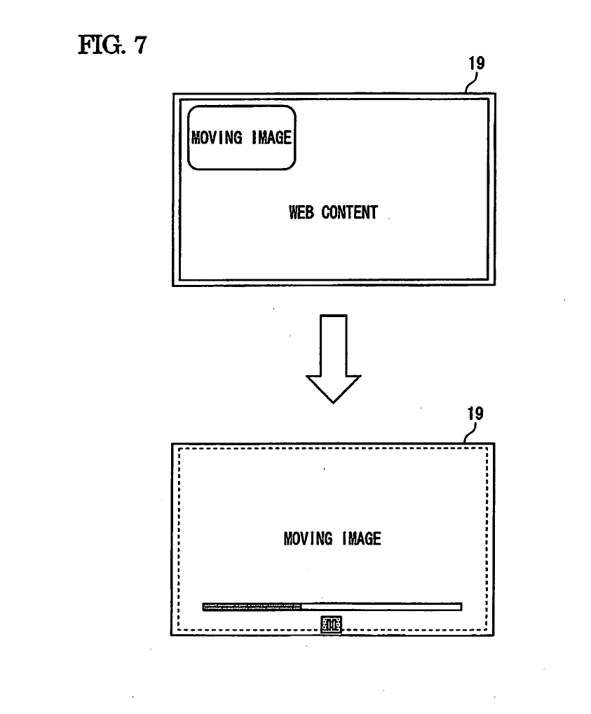

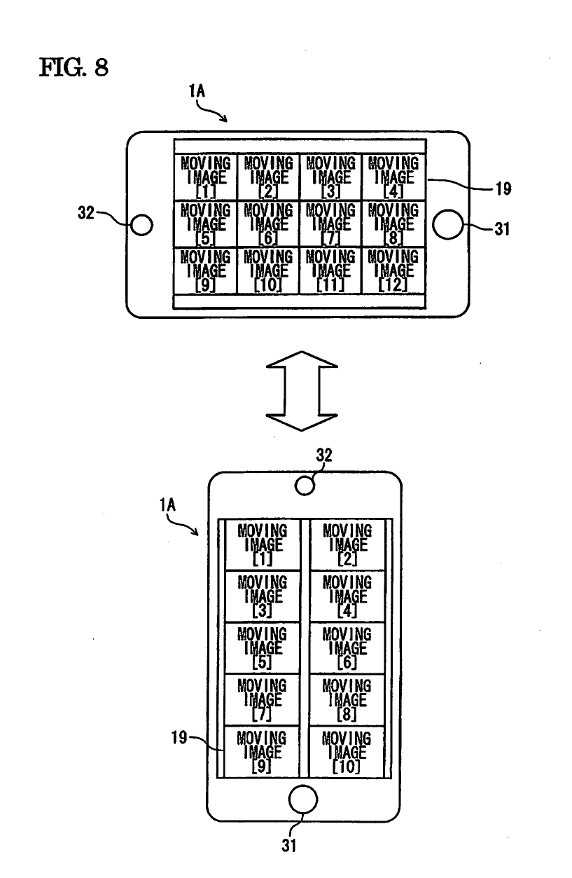

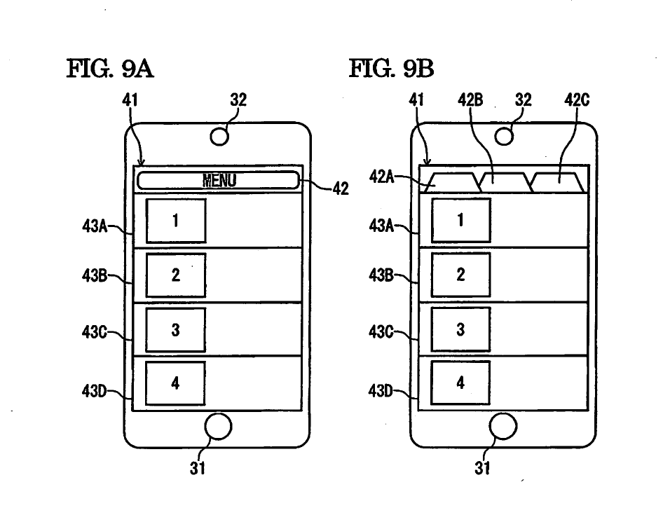

Referring to FIG. 2A, FIG. 2B and FIG. 2C, materials to implement an embodiment of the invention are a fabric panel 30, a poster board 32, which may have a foam core, and may be of other suitable materials, and needs to be thick enough (for example ¼ inch) to provide stability and to resist bending when a guest is writing on it, a backing 34, a number of small sewing pins with small heads, and/or tape. When the final printed fabric panel 30 is received, it is then mounted on the foam-core poster board 32. Before it mounted, some careful ironing is done to remove wrinkles and creasing.

It will be understood that while the poster board materials described above are preferred, the term is general, and may refer to a board formed of wood, cardboard, a polymer (such as Lucite®), a metal, or other structural materials.

As shown in FIG. 2D, the fabric panel is placed with the printed side face down on a table, with its back facing up. As shown in FIG. 2E, the board is intentionally smaller than the finished soft-home decorative keepsake item will be. The poster board 32 is placed over the fabric panel 30, and the dimensions of each are preferably chosen, so that the poster board 32 is centered on the fabric panel 30 with a uniform boarder around the entire periphery.

Referring to FIG. 2F, the edges of the printed fabric panel 30 are wrapped around the poster board 32, and part of the image is intentionally fastened to the back of the board. The fabric is pulled taut and then taped in place by tape (not shown). Optionally, for extra stability, as illustrated in FIG. 2G, the aforementioned sewing pins 36 are placed on the edge of the poster board 32, preferably around its entire periphery, helping to secure the fabric panel 30 in place.

Since event guests will write on any surface presented to them, the wrapping of the fabric of the fabric panel 30 around the back of the board 32 allows for a clear, signature free border so that in construction of the final keepsake item, no signatures are cut off. For a 30 inch×30 inch finished pillow, for example, the board will be preferably approximately 27 inches×27 inches (but may be larger, as long as a suitable boarder is maintained), providing 1.5 inches turned under to the back of the sign-in board and unavailable to guests for all four sides of the board. This mounting can be done by a reasonably well skilled person in the crafts, but can also be done by a professional framer. The important result is that the fabric be wrapped tightly over the board and secured thereto. Preferably, the back of the assembly is covered with the backing 34, so that the raw edges of the fabric and the tape are not visible. Alternatively the board assembly 38 can be framed, at least on a temporary basis.

Referring to FIG. 2I, at the event, the board assembly 38 is usually placed on an easel (not shown), although it could be set on a table leaning against a wall, or even hung on the wall like a picture. The guests use permanent markers (not shown) provided by either the fabricator or the client, to place their contributions on the exposed portion of the fabric panel 30 of the board assembly 38.

As shown in FIG. 2J, when the board assembly 38 is returned to the fabricator the tape (not shown) and the pins 36, if used, are removed, and the fabric panel is removed from the board. Alternatively, the client can remove the pins and send the fabric back to the fabricator. If it is sent back, it should be sent back in a tube and covered with tissue paper to minimize creasing and bleeding of ink, but the client often just folds it up and puts it in an oversized envelope.

As illustrated in FIG. 2K, the border area fabric that was folded behind the poster board 32 allows a pillow or other fabric keepsake to be made with a clean border, without cutting off any signatures or other markings made by guests at the event.

The client has three decisions to make by this time (it can be done earlier) 1. Do they want any cording, trim or any other embellishments for the keepsake? 2. What type of fill do they want inside the keepsake? and 3. What color or design do they want for the back of the keepsake? A back may be created, that may be just color-matched to the front, or an image may be used on the back. It gets printed, as does fabric for the cording (which may also be color-matched). Ready-made cording and fabric may be purchased for the client. The client can decide not to have a pillow made, but instead a tablecloth or even a wall hanging using the fabric.

The item is then made up. If it is a pillow, zippers are placed on the bottom edge. Tablecloths or wall-hangings or other items can also be made with standard sewing techniques and materials.

In accordance with another embodiment of the invention, an existing sign-in board is made into a fabric item. One, or a series, of high quality photographs of an existing conventional sign-in board are taken, with overlapping areas of a series. Then, computer graphics and digital photography software are used to knit the images together to recreate the whole. Computer color correction, etc. may be necessary at this point, as well as some additional computer graphics. Once the images are knitted together, they are printed on fabric and the procedure continues as above.

The invention has several major advantages over what has been done before.

1. A fabric keepsake, with practical uses in a home or office, can be made.

2. The image may be stored in digital form so that additional keepsakes similar to one initially produced, or in a different form, may be made, even years later, if the original keepsake is lost or destroyed.

3. The digital processing enables the image to be produced on the keepsake to be enhanced, including improving its quality, or its content, electronically.

4. The second embodiment of the invention can be helpful in making identical keepsakes for twins (who may have one sign-in board for a joint event, but can get two keepsakes from it) or for a larger group where everybody signs (such as a reunion) and then multiple versions can be made.

5. Keepsakes having the same image can be made in various sizes by appropriate scaling of the digital image.

While preferred material and techniques have been described, it is possible to use other means for fastening the fabric to the poster board. For example, staples can be used, but are believed to be less desirable due to the possibility of damaging the fabric upon removal.

It should be understood that the foregoing description is only illustrative of the invention. Various alternatives and modifications can be devised by those skilled in the art without departing from the invention. Accordingly, the present invention is intended to embrace all such alternatives, modifications and variances, which fall within the scope of the claims.

What is claimed is:

1. A method for producing a fabric keepsake, comprising:
placing a fabric removeably on a poster board so as to form a sign-in board to be used at an event, so that a surface of the fabric is exposed for marking by guests at the event;
removing the fabric from the poster board after the sign-in board has been marked by at least one person, at the event; and
forming a keepsake using the fabric.

2. The method of claim 1, further comprising: placing an image on the fabric prior to the fabric being fastened to the poster board.

3. The method of claim 2, wherein the image is placed on the fabric by printing on the fabric.

4. The method of claim 2, wherein the image is processed to improve at least one of color and clarity prior to being placed on said fabric.

5. The method of claim 2, wherein the image is processed using a software program on a computer.

6. The method of claim 2, further comprising acquiring the image from a customer of the keepsake, from a library of images, or based on a design created by a fabricator.

7. The method of claim 2, wherein the image is acquired as a digital image file.

8. The method of claim 2, further comprising printing a test image on the fabric to review quality of the image, prior to the fabric being placed on the poster board.

9. The method of claim 8, further comprising additional processing of the image if quality of the image is not as is desired.

10. The method of claim 1, wherein the poster board is of smaller dimensions than the fabric so as to provide a border of fabric that is not marked at the event.

11. The method of claim 1, further comprising temporarily framing the poster board for use at the event.

12. The method of claim 1, wherein the fabric is placed on the poster board by folding a periphery of the fabric so as to contact a side of the poster board that is not to be exposed for marking during the event; and fastening the periphery of the fabric to the side that is not to be exposed for marking.

13. The method of claim 12, wherein the fastening is done by using tape to fasten the periphery of the fabric to the side of the poster board that is not to be exposed for marking.

14. The method of claim 1, wherein the poster board has a foam core.

15. The method of claim 14, wherein the fabric is placed on the poster board by using pins extending into the foam core, to secure the fabric peripherally about the poster board.

16. The method of claim 15, further comprising: folding a periphery of the fabric so as to contact a side of the poster board that is not to be exposed for marking during the event; and fastening the periphery of the fabric to the side that is not to be exposed for marking.

17. The method of claim 16, wherein the fastening is done by using tape to fasten the periphery of the fabric to the side of the poster board that is not to be exposed for marking.

18. The method of claim 1, further comprising ironing the fabric before it has been placed on the poster board to remove wrinkles in the fabric.

19. The method of claim 1, further comprising:
producing an image of the fabric after it has been marked at the event; and
storing the image for later use in producing a keepsake.

20. The method of claim 1, wherein the fabric is used to form a keepsake selected from the group consisting of a pillow, a wall hanging, a quilt, a blanket and a table covering.

21. The method of claim 1, wherein the fabric is used to form a keepsake, further comprising, specifying at least one of:
whether the keepsake is to have embellishments;
whether a fill is placed in the keepsake; and
one of a color or a design for fabric used to form a back of the keepsake.

22. A method for producing a fabric keepsake, comprising:
printing an image of a poster board that has been marked up at an event, on a fabric; and
forming a keepsake using the fabric.

23. The method of claim 22, wherein the fabric is used to form a keepsake selected from the group consisting of a pillow, a wall hanging, a blanket, a quilt and a table covering.

24. The method of claim 22, further comprising:
using an image capture device to capture the image of the sign-in board, and to provide a digital file representative of the image; and
using the digital file to print the image.
